(19) United States
(12) Patent Application Publication
(10) Pub. No.: US 2008/0088939 A1
(43) Pub. Date: Apr. 17, 2008

(54) Liquid-lens module

(75) Inventor: Moon Sik Jung, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/724,309

(22) Filed: Mar. 15, 2007

(30) Foreign Application Priority Data
Oct. 11, 2006 (KR) 10-2006-0098934

(51) Int. Cl. G02B 3/12

(52) U.S. Cl. 359/665

(57) ABSTRACT

Disclosed herein is a current transmitting structure for a liquid-lens module using an electrowetting phenomenon. The present invention is characterized in that it uses an FPC to apply electricity to the liquid-lens module.

### CROSS REFERENCE TO RELATED APPLICATION(S)

This application claims the benefit of Korean Patent Application No. 10-2006-0098934, filed on Oct. 11, 2006, entitled “liquid-lens module”, which is hereby incorporated by reference in its entirety into this application.

### BACKGROUND OF THE INVENTION

1. Field of the Invention

The present invention relates generally to a liquid-lens module using an electrowetting phenomenon and, more particularly, to a liquid-lens module, which simplifies the construction for applying current to the liquid-lens module.

2. Description of the Related Art

Currently, a camera having a controllable focus function is applied to various kinds of portable multimedia equipment, including a mobile communication terminal, a small digital camera, an automatic camera, etc. As technology is gradually developed, efforts to integrate various devices, including a camera, into a single piece of mobile equipment and miniaturize the equipment have been continuously conducted.

In the case of a conventional camera having the controllable focus function, a conventional lens having the controllable focus function is constructed to move along the optical axis of the lens because physical movement of the lens is required in order to set the focus. Hence, the conventional camera must have a large size to some extent. Further, since additional parts required for driving the lens, such as a motor, must be mounted, it is difficult to realize miniaturization of the camera.

Recently, as a camera equipped with a lens having a controllable focus function has been attached to a portable terminal, miniaturization of the camera is more keenly required. Further, when the controllable focus lens is driven in the mechanical method, as in the prior art, problems other than the above-mentioned problems occur. That is, since an electric motor installed to drive the controllable focus lens consumes a considerable amount of battery power, it is technically difficult to mount the controllable focus lens to a mobile terminal. Moreover, in order to control the focus of the lens using the conventional mechanical method, a certain amount of time is required.

Thus, in order to solve the problems, recently, a liquid lens using an electrowetting method has been proposed as an alternative to a conventional zoom lens operated by the mechanical method. Research on the liquid lens has been actively conducted.

The basic construction and function of the liquid lens will be briefly described with reference to PCT WO 03/069380, which discloses the invention dealing with the liquid lens.

FIG. 1 is a schematic sectional view showing the liquid lens disclosed in PCT WO 03/069380. The liquid lens will be described with reference to the drawing. As shown in FIG. 1, the liquid lens includes a cylindrical fluid chamber 5, a fluid contact layer 10, a first electrode 2, and a second electrode 12. The fluid chamber 5, having a cylindrical wall, holds a first fluid A and a second fluid B which have different refractive indices, are in contact over a meniscus 14, and are non-miscible. The fluid contact layer 10 is arranged on the inside of the cylindrical wall. The first electrode 2 is separated from the first fluid A and the second fluid B by the fluid contact layer 10. The second electrode 12 functions to activate the second fluid B.

In this case, the first electrode 2 has a cylindrical shape, is coated with an insulating layer 8, and is made of a metallic material. The second electrode 12 is positioned on one side of the fluid chamber 5. Further, a transparent front part 4 and a transparent rear part 6 form a cover of the fluid chamber 5, which holds the two fluids therein.

The operation of the liquid lens, constructed as described above, is as follows.

When no voltage is applied between the first and second electrodes 2 and 12, the fluid contact layer 10 has higher wettability by the first fluid A compared to the second fluid B. If voltage V1, V2, or V3 is applied between the first and second electrodes 2 and 12, the wettability relative to the second fluid B varies because of the electrowetting effect, and the contact angle Q1, Q2, or Q3 of the meniscus 14 with the liquid contact layer 10 varies, as shown in the drawings. Thus, the shape of the meniscus 14 varies depending on the applied voltage, and the focus of the liquid lens is controlled using the variation in shape of the meniscus 14.

That is, as shown in FIGS. 1 to 3, the angle between the meniscus 14 and the fluid contact layer 10 measured at the first fluid B according to the magnitude of applied voltage is changed from an obtuse angle to an acute angle, e.g., 140°, 100°, and 60°. In this case, FIG. 1 shows an arrangement having high negative power, FIG. 2 shows an arrangement having low negative power, and FIG. 3 shows an arrangement having positive power. Such a liquid lens using the fluids is advantageous to realize miniaturization of the equipment and reduce power consumption, compared to the conventional lens, the focus of which is controlled in the mechanical driving method.

Meanwhile, as shown in FIGS. 1 to 3, the conventional liquid-lens module is constructed so that an electric wire 15 is directly connected to the liquid-lens module to apply current to the fluid.

However, as described above, according to the conventional method of directly connecting the electric wire to the liquid-lens module, the electric wire must be connected to a connecter which is provided outside the liquid-lens module. Thus, the electric wire must be additionally treated outside the module. Further, since the electric wire is provided outside the liquid-lens module, the appearance thereof is untidy. Furthermore, the method of applying current through the electric wire is problematic in that the reliability of the power supply is low, and thus an optical error may occur.

The basic operational principle and construction of the liquid lens are described with reference to the drawings. The overall construction of a liquid lens assembly, required to apply the liquid-lens module to an end product in practice, and the concrete method of applying current have not been disclosed yet.

Therefore, the applicant of this invention proposes ways to solve the above-mentioned problems.

### SUMMARY OF THE INVENTION

Accordingly, the present invention has been made keeping in mind the above problems occurring in the prior art, and an object of the present invention is to provide a liquid-lens module, which realizes a simpler and more reliable structure using a flexible printed circuit board (FPC), thus applying current to the liquid-lens module.

In order to accomplish the above object, the present invention provides a liquid-lens module including a fluid chamber which has an open space therein, two fluids which are injected into the fluid chamber, are separated from each other by an interface, and have different refractive indices, a transparent plate which seals the open space of the fluid chamber using an adhesive means, and two electrodes which are arranged to act on the fluids in the fluid chamber and comprise first and second electrodes. In this case, the liquid-lens module applies current to the two electrodes using an FPC.

An FPC coupling unit, contacting the two electrodes of the liquid-lens module, comprises two contact parts each having a terminal which contacts each of the electrodes of the module.

### BRIEF DESCRIPTION OF THE DRAWINGS

The above and other objects, features and advantages of the present invention will be more clearly understood from the following detailed description taken in conjunction with the accompanying drawings, in which:

FIGS. 1 to 3 are sectional views showing the construction and operation of a conventional liquid lens;

FIG. 4 is a view showing an FPC coupling unit used in a liquid-lens module, according to an embodiment of the present invention;

FIG. 5 is a view showing the state where the FPC coupling unit of FIG. 4 is mounted to the liquid-lens module;

FIG. 6 is a view showing an FPC coupling unit, according to another embodiment of the present invention; and

FIG. 7 is a view showing the state where the FPC coupling unit of FIG. 6 is mounted to the liquid-lens module.

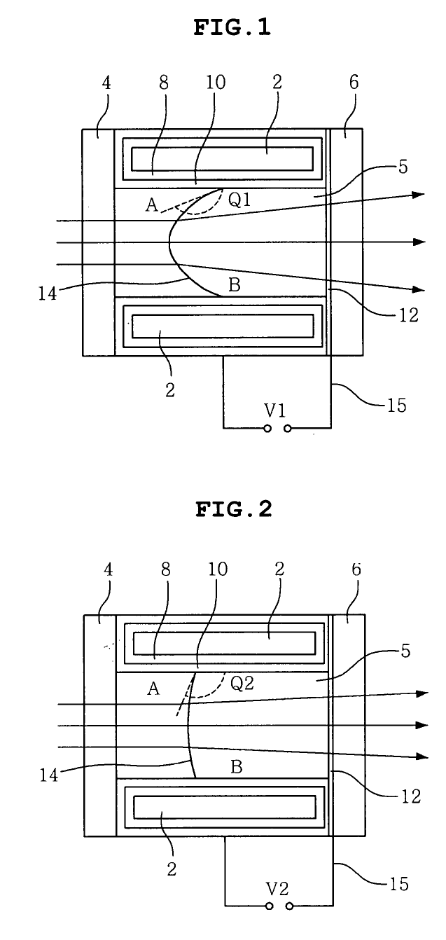

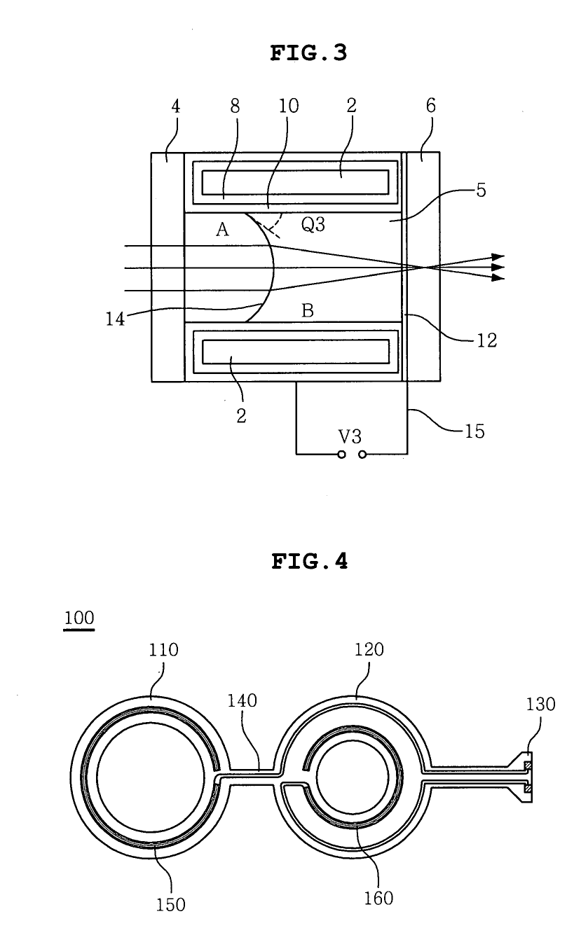

### DESCRIPTION OF THE PREFERRED EMBODIMENTS

Hereinafter, the present invention will be described in detail with reference to the accompanying drawings.

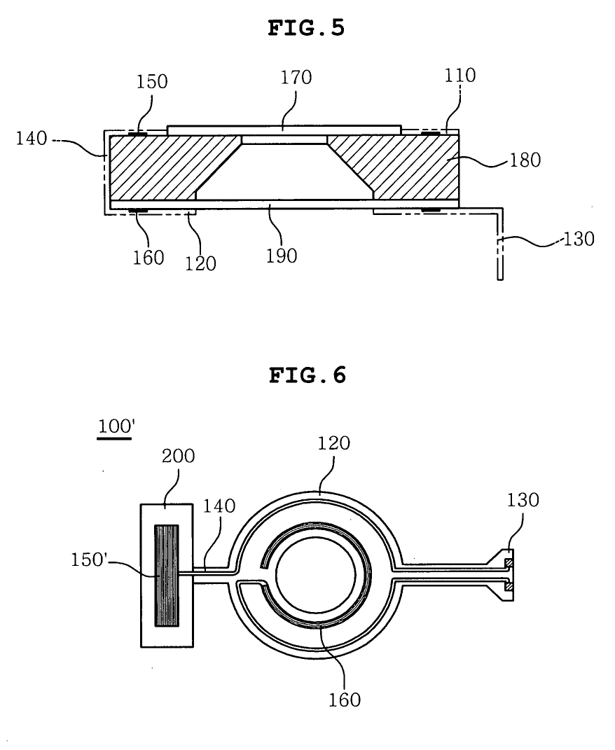

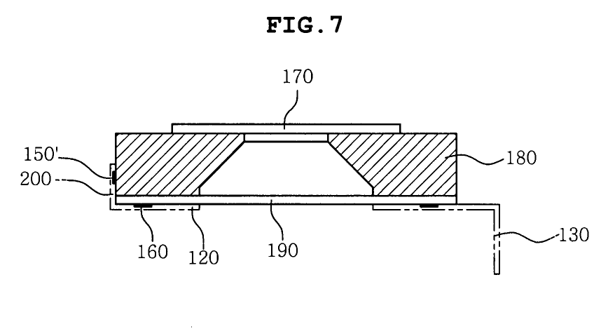

FIG. 4 is a view showing an FPC coupling unit used in a liquid-lens module, according to an embodiment of the present invention, FIG. 5 is a view showing the state where the FPC coupling unit of FIG. 4 is mounted to the liquid-lens module, FIG. 6 is a view showing an FPC coupling unit, according to another embodiment of the present invention, and FIG. 7 is a view showing the state where the FPC coupling unit of FIG. 6 is mounted to the liquid-lens module.

The liquid-lens module using the FPC coupling unit according to the present invention will be described in detail with reference to FIGS. 4 and 5.

FIG. 4 shows the flexible printed circuit board (FPC) coupling unit 100 for applying current to the liquid-lens module, according to an embodiment of the present invention. The FPC coupling unit 100 includes an upper contact part 110, a lower contact part 120, and a connecting terminal part 130. The upper contact part 110 contacts an electrode which is provided on the upper surface of the liquid-lens module. The lower contact part 120 contacts an electrode which is provided on the lower surface of the liquid-lens module. The connecting terminal part 130 is connected to a power supply unit which is provided outside the liquid-lens module. In this case, the upper contact part 110 and the lower contact part 120 are coupled to each other via a coupler 140. A first terminal 150 and a second terminal 160 are provided on the upper contact part 110 and the lower contact part 120 of the FPC coupling unit 100, constructed as described above, respectively, and contact respective electrodes of the liquid-lens module. Each of the terminals 150 and 160 is plated with gold.

Each of the upper and lower contact parts 110 and 120 of the FPC coupling unit 100 shown in FIG. 4 has a doughnut shape. Such a shape permits the attachment of the FPC coupling unit 100 within the range in which an optical path passing through the upper and lower surfaces of the liquid-lens module having the FPC coupling unit 100 is not hindered.

FIG. 5 shows the state where the FPC coupling unit 100 according to this invention is mounted to the liquid-lens module. The current applying structure of the liquid-lens module according to the present invention will be described with reference to the drawings. In this case, the electrodes of the liquid-lens module are provided on the upper surface of a fluid chamber 180 and a lower cover 190 provided on the lower surface of the fluid chamber 180.

Referring to the drawings, the upper contact part 110 of the FPC coupling unit 100 is attached to the upper surface of the fluid chamber 180 of the liquid-lens module, so that the first terminal 150 provided on the upper contact part 110 contacts the electrode provided on the upper surface of the fluid chamber 180. The lower contact part 120 of the FPC coupling unit 100 is attached to the lower cover 190 provided on the lower surface of the fluid chamber 180 of the liquid-lens module, so that the second terminal 160 provided on the lower contact part 120 contacts the electrode provided on the lower cover 190. The upper and lower contact parts 110 and 120 are coupled to each other via the coupler 140. The connecting terminal part 130 connected to the lower contact part 120 is connected to the external power supply unit. As described above, according to this invention, the FPC coupling unit 100 is bent in a U shape, and is connected to the two electrodes provided in the liquid-lens module.

As such, the FPC coupling unit 100 according to this invention functions to apply current to the liquid-lens module. The present invention has a technical advantage in that current can be applied to both electrodes of the liquid-lens module at one time by using the FPC coupling unit 100. Further, the invention uses the FPC coupling unit 100, thus having a simpler structure and enhancing the reliability of the current application.

FIGS. 6 and 7 show another embodiment of the present invention. The current applying structure of the liquid-lens module according to the present invention will be described with reference to the drawings. This embodiment relates to an FPC coupling unit 100′ which is useful when two electrodes of the liquid-lens module are provided on the upper and side surfaces or the side and lower surfaces thereof.

Referring to FIG. 6, the FPC coupling unit 100′ according to this invention includes a side contact part 200, a lower contact part 120, a connecting terminal part 130, and a coupler 140. The side contact part 200 contacts an electrode which is provided on the side surface of the liquid-lens module. The lower contact part 120 contacts an electrode which is provided on the lower surface of the liquid-lens module. The connecting terminal part 130 is connected to a power supply unit which is provided outside the liquid-lens module. The side contact part 200 and the lower contact part 120 are coupled to each other via the coupler 140. A first terminal 150′ and a second terminal 160 are provided on the side contact part 200 and the lower contact part 120 of the FPC coupling unit 100, respectively, and contact respective electrodes of the liquid-lens module. Each of the terminals 150′ and 160 is plated with gold.

As described above, the lower contact part 120 of the FPC coupling unit 100′ shown in FIG. 6 has a doughnut shape. Such a shape permits the attachment of the FPC coupling unit 100′ within the range where an optical path formed in the lower surface of the liquid-lens module having the FPC coupling unit 100′ is not hindered. In this case, the side contact part 200 of the FPC coupling unit 100′ contacting the electrode which is provided on the side surface of the liquid-lens module has a rectangular shape. However, the shape of the side contact part 200 is not limited to the rectangular shape.

FIG. 7 shows the state where the FPC coupling unit 100′ of the invention is mounted to the liquid-lens module. The current applying structure of the liquid-lens module according to this invention will be described with reference to the drawing. In this case, the electrodes of the liquid-lens module are provided on the side surface of the fluid chamber 180 and a lower cover 190 provided on the lower surface of the fluid chamber 180.

Referring to the drawings, the side contact part 200 of the FPC coupling unit 100′ is attached to the side surface of the fluid chamber 180 of the liquid-lens module, so that the first terminal 150′ provided on the side contact part 200 contacts the electrode which is provided on the side surface of the fluid chamber 180. The lower contact part 120 of the FPC coupling unit 100′ is attached to the lower cover 190 which is provided on the lower surface of the fluid chamber 180 of the liquid-lens module. Thus, the second terminal 160 provided on the lower contact part 120 contacts the electrode provided on the lower cover 190. The side contact part 200 and the lower contact part 120 are coupled to each other via the coupler 140, and are connected to an external power supply unit via the connecting terminal part 130, which is connected to the lower contact part 120. According to this embodiment, the FPC coupling unit 100′ of this invention is bent in an L shape and is connected to the two electrodes provided in the liquid-lens module.

As described above, the FPC coupling unit according to this invention has one of a variety of specific shapes. However, the shape of the FPC coupling unit is not limited to the above-mentioned shapes. As long as the FPC coupling unit is integrally coupled to the two electrodes of the liquid-lens module and applies current to the two electrodes, the FPC coupling unit may have any shape. The liquid-lens module according to this invention adopts a current applying structure using the FPC, thus achieving a simpler and more reliable current applying structure. Further, by adopting the current applying structure using the FPC, a smaller liquid-lens module can be realized.

As described above, the present invention provides a liquid-lens module, which simplifies the structure for applying current to the liquid-lens module, thus increasing operational reliability compared to the conventional method.

Further, the present invention provides a liquid-lens module, which applies current using an FPC, thus realizing the miniaturization of the liquid-lens module.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A liquid-lens module for controlling focus using an electrowetting method, comprising:
a fluid chamber having an open space therein;
two fluids injected into the fluid chamber, separated from each other by an interface, and having different refractive indices;
a transparent plate sealing the open space of the fluid chamber using adhesive means; and
two electrodes arranged to act on the fluids in the fluid chamber, wherein the liquid-lens module applies current to the two electrodes using an FPC.

2. The liquid-lens module as set forth in claim 1, wherein an FPC coupling unit, contacting the two electrodes of the liquid-lens module, comprises two contact parts each having a terminal which contacts each of the electrodes of the liquid-lens module.

3. The liquid-lens module as set forth in claim 2, wherein, when the two electrodes of the liquid-lens module are provided on upper and lower surfaces of the module, the FPC coupling unit is bent in a U shape, so that the two contact parts of the FPC coupling unit contact the two electrodes of the liquid-lens module, respectively.

4. The liquid-lens module as set forth in claim 3, wherein each of the upper and lower contact parts of the FPC coupling unit has a doughnut shape.

5. The liquid-lens module as set forth in claim 2, wherein, when the two electrodes of the liquid-lens module are provided on upper and side surfaces, or on side and lower surfaces of the module, the FPC coupling unit is bent in an L shape, so that the two contact parts of the FPC coupling unit contact respective electrodes of the liquid-lens module.

6. The liquid-lens module as set forth in claim 5, wherein each of the upper and lower contact parts of the FPC coupling unit has a doughnut shape, and the side contact part has a rectangular shape.

7. The liquid-lens module as set forth in claim 2, wherein the terminal of the FPC coupling unit is plated with gold.
